(19) United States
(12) Patent Application Publication
(10) Pub. No.: US 2012/0024477 A1
(43) Pub. Date: Feb. 2, 2012

(54) ROOM TEMPERATURE CURING EPOXY ADHESIVE

(76) Inventor: Michael A. Kropp, Cottage Grove, MN (US)

(21) Appl. No.: 13/147,380

(22) PCT Filed: Feb. 3, 2010
(86) PCT No.: PCT/US2010/023033

§ 371 Date: Aug. 2, 2011

Related U.S. Application Data
(60) Provisional application No. 61/150,443, filed on Feb. 6, 2009.

(51) Int. Cl. B67D 7/74; C09J 163/00; C09J 163/02

(52) U.S. Cl. 156/330; 528/87; 525/523; 525/480; 525/122

(57) ABSTRACT

Room temperature curing epoxy adhesives are described. The adhesives contain an epoxy resin, an acetoacetoxy-functionalized compound, a metal salt catalyst, a first amine curing agent having an equivalent weight of at least 50 grams per weight of amine equivalents and a second amine curing agent having an equivalent weight of no greater than 45 grams per weight of amine equivalents.

### FIELD

The present disclosure relates to room temperature curable epoxy adhesives, particularly two-part epoxy adhesives that, when cured at room temperature, perform as structural adhesives.

### SUMMARY

Briefly, in one aspect, the present disclosure provides an adhesive comprising an epoxy resin; a first amine curing agent having an equivalent weight of at least 50 grams per mole of amine equivalents; a second amine curing agent having an equivalent weight of no greater than 45 grams per mole of amine equivalents; an acetoacetoxy-functionalized compound; and a metal salt catalyst.

In some embodiments, the epoxy resin has the general formula of

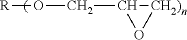

wherein, R comprises one or more aliphatic, cycloaliphatic, and/or aromatic hydrocarbon groups, optionally wherein R further comprises at least one ether linkage between adjacent hydrocarbon groups; and n is an integer greater than 1. In some embodiments, the epoxy resin comprises a glycidyl ether of bisphenol-A, bisphenol-F, or novolac.

In some embodiments, the equivalent weight of the first amine curing agent is at least 55 grams per mole of amine equivalents. In some embodiments, the equivalent weight of the second amine curing agent is no greater than 40 grams per mole of amine equivalents. In some embodiments, the relative amounts of low equivalent weight amine curing agent and high equivalent weight amine curing agent are selected such that the low equivalent weight amine curing agent composes at least 25 wt. % of the combined weight of the low and high equivalent weight amine curing agents, e.g., in some embodiments, the relative amounts of low equivalent weight amine curing agent and high equivalent weight amine curing agent are selected such that the low equivalent weight amine curing agent composes between 30 and 60 wt. %, inclusive, of the combined weight of the low and high equivalent weight amine curing agents.

In some embodiments, at least one amine curing agent, in some embodiments, both amine curing agents, have the formula

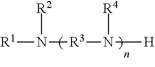

wherein, R¹, R², and R⁴, are independently selected from hydrogen, a hydrocarbon containing 1 to 15 carbon atoms, and a polyether containing 1 to 15 carbon atoms; R³ represents a hydrocarbon containing 1 to 15 carbon atoms or a polyether containing 1 to 15 carbon atoms; and n is from 1 to 10, inclusive.

In some embodiments, the acetoacetoxy-functionalized compound has the general formula:

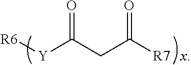

wherein, x is an integer from 1 to 10; Y represents O, S or NH; R⁶ is selected from the group consisting of polyoxy, polyhydroxy, polyoxy polyhydroxy, and polyhydroxy polyester-alkys, -aryls, and -alkylaryls; wherein R1 is linked to Y via a carbon atom; and R7 is a linear or branched or cyclic alkyl having 1 to 12 carbon atoms.

In some embodiments, the metal salt catalyst comprises calcium triflate. In some embodiments, the adhesive comprises 0.3 to 1.5 wt. % catalyst, based on the total weight of the composition.

In some embodiments, the adhesive further comprises a toughening agent; e.g., a core shell polymer and/or a butadiene-nitrile rubber. In some embodiments, the adhesive further comprising an aromatic tertiary amine.

In some aspects of the present disclosure, the adhesive comprises two components. The first component comprises the acetoacetoxy-functionalized compound and at least a portion of the epoxy resin, and the second component comprises the first amine curing agent, the second amine curing agent, and the metal salt catalyst. In some embodiments, the second component further comprises a portion of the epoxy resin.

In some embodiments, the adhesive has a gel time at 25° C. of no greater than 20 minutes as measured according to the Gel Time Test Method. In some embodiments, when cured at 23° C., the adhesive has an over-lap shear value of at least 0.34 MPa after no greater than 30 minutes, as measured according to the Rate of Strength Buildup Test Method.

In another aspect, the present disclosure provides an adhesive dispenser comprising a first chamber containing a first component of a two-part adhesive, a second chamber containing a second component of the two-part adhesive, and a mixing tip, wherein the first and second chambers are coupled to the mixing tip to allow the first component and the second component to flow through the mixing tip. The first component comprises an epoxy resin and an acetoacetoxy-functionalized compound and the second component comprises a first amine curing agent having an equivalent weight of at least 50 grams per mole of amine equivalents; a second amine curing agent having an equivalent weight of no greater than 45 grams per mole of amine equivalents; and a metal salt catalyst.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

Structural adhesives are useful in many bonding applications. For example, structural adhesives may be used to replace or augment conventional joining techniques such as welding or the use of mechanical fasteners such as nuts and bolts, screws, rivets, and the like.

Generally, structural adhesives may be divided into two broad categories: one-part adhesives and two-part adhesives. With a one-part adhesive, a single composition comprises all the materials necessary to obtain a final cured adhesive. Such adhesives are typically applied to the substrates to be bonded and exposed to elevated temperatures (e.g., temperatures greater than 50° C.) to cure the adhesive.

In contrast, two-part adhesives comprise two components. The first component, typically referred to as the “base resin component,” comprises the curable resin, e.g., a curable epoxy resin. The second component, typically referred to as the “accelerator component,” comprises the curing agent(s) and catalysts. Various other additives may be included in one or both components.

Generally, the two components of a two-part adhesive are mixed prior to being applied to the substrates to be bonded. After mixing, the two-part adhesive gels, reaches a desired handling strength, and ultimately achieves a desired final strength. Some two-part adhesives must be exposed to elevated temperatures to cure, or at least to cure within a desired time. However, it may be desirable to provide structural adhesives that do not require heat to cure (e.g., room temperature curable adhesives), yet still provide high performance in peel, shear, and impact resistance.

As used herein, “gel time” refers to the time required for the mixed components to reach the gel point. As used herein, the “gel point” is the point where the mixture's storage modulus exceeds its loss modulus.

“Handling strength” refers to the ability of the adhesive to cure to the point where the bonded parts can be handled in subsequent operations without destroying the bond. The required handling strength varies by application. As used herein, “initial cure time” refers to the time required for the mixed components to reach an overlap shear adhesion of 0.34 MPa (50 psi); which is a typical handling strength target. Generally, the initial cure time correlates with the gel time; i.e., shorter gel times typically indicate adhesives with shorter initial cure times.

Generally, the bond strength (e.g., peel strength, overlap shear strength, or impact strength) of a structural adhesive continues to build well after the initial cure time. For example, it may take hours or even days for the adhesive to reach its ultimate strength.

Exemplary two-part structural adhesives include those based on acrylic, polyurethane, and epoxy chemistries. Epoxy-based, two-part structural adhesives typically offer high performance in peel strength and shear strength, even at elevated temperatures. Common curatives are typically amine- or mercapto-functional materials, and many variations of these compounds are available for epoxy curing. However, most amine-cured room temperature curing epoxy-based adhesives are relatively slow curing and can take several hours to reach handling strength. Catalysts, typically tertiary amines, phenol functional resins, and some metal salts can accelerate these cures. Still, the initial cure time at room temperature for epoxy adhesives is typically much longer than the initial cure time for acrylic adhesives.

In some embodiments, the present disclosure provides fast, room temperature curable, two-part epoxy adhesives. In some embodiments, these adhesives provide room temperature gel times and initial cure times of less than 20 minutes in adhesive bond thicknesses of up to 0.5 millimeters (20 mils). In some embodiments, these adhesives can be free of mercaptan and acrylic functionality, which can be undesirable in certain applications.

Generally, the adhesives of the present disclosure comprise an epoxy resin, a high equivalent weight amine curing agent, a low equivalent weight amine curing agent, an acetoacetoxy-functionalized compound, and a metal salt catalyst.

Epoxy Resins. Epoxy resins that are useful in the compositions of the present disclosure are of the glycidyl ether type. Useful resins include those having the general Formula (I):

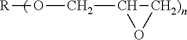

wherein

R comprises one or more aliphatic, cycloaliphatic, and/or aromatic hydrocarbon groups, optionally wherein R further comprises at least one ether linkage between adjacent hydrocarbon groups; and

n is an integer greater than 1.

Generally, n is the number of glycidyl ether groups and must be greater than 1 for at least one of the epoxy resins of Formula I present in the adhesive. In some embodiments, n is 2 to 4, inclusive.

Exemplary epoxy resins include glycidyl ethers of bisphenol A, bisphenol F, and novolac resins as well as glycidyl ethers of aliphatic or cycloaliphatic diols. Examples of commercially available glycidyl ethers include diglycidylethers of bisphenol A (e.g. those available under the trade names EPON 828, EPON 1001, EPON 1310 and EPON 1510 from Hexion Specialty Chemicals GmbH, Rosbach, Germany, those available under the trade name D.E.R. from Dow Chemical Co. (e.g., D.E.R. 331, 332, and 334), those available under the trade name EPICLON from Dainippon Ink and Chemicals, Inc. (e.g., EPICLON 840 and 850) and those available under the trade name YL-980 from Japan Epoxy Resins Co., LTD.); diglycidyl ethers of bisphenol F (e.g. those available under the trade name EPICLON from Dainippon Ink and Chemicals, Inc. (e.g., EPICLON 830)); glycidyl ethers of novolac resins (e.g., novolac epoxy resins, such as those available under the trade name D.E.N. from Dow Chemical Co. (e.g., D.E.N. 425, 431, and 438)); and flame retardant epoxy resins (e.g. D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred. In some embodiments, nitrile rubber modified epoxies may be used (e.g., KELPDXY 1341 available from CVC Chemical).

In some embodiments, the epoxy resin has a molecular weight of at least 170, e.g., at least 200 g/mole. In some embodiments, the epoxy resin has a molecular weight of no greater than 10,000, e.g., no greater than 3,000 g/mol. In some embodiments, the epoxy equivalent weight of the resin is at least 50, in some embodiments, at least 100 g/mole of epoxy equivalents. In some embodiments, the epoxy equivalent weight of the resin is no greater than 500, in some embodiments, no greater than 400 g/mole of epoxy equivalents

In some embodiments, the compositions of the present disclosure comprise at least 20 wt. %, e.g., at least 25 wt. %, or even at least 30 wt. % epoxy resin, based on the total weight of the composition. In some embodiments, the compositions of the present disclosure comprise no greater than 90 wt. %, e.g., no greater than 75 wt. %, or even no greater than 60 wt. % epoxy resin, based on the total weight of the composition.

As used herein, the phrase “total weight of the composition” refers to the combined weight of both components, i.e., the base resin component and the accelerator component.

Amine Curing Agents. Suitable curing agents are compounds which are capable of cross-linking the epoxy resin. Typically, these agents are primary and/or secondary amines. The amines may be aliphatic, cycloaliphatic, or aromatic. In some embodiments, useful amine curing agents include those having the general Formula (II)

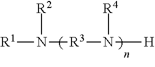

wherein

R¹, R², and R⁴, are independently selected from hydrogen, a hydrocarbon containing 1 to 15 carbon atoms, and a polyether containing up to 15 carbon atoms;

R³ represents a hydrocarbon containing 1 to 15 carbon atoms or a polyether containing up to 15 carbon atoms; and

n is from 1 to 10, inclusive.

The adhesives of the present disclosure comprise at least two amine curing agents. One amine curing agent is a low equivalent weight amine curing agent, i.e., an amine curing agent having an amine equivalent weight of no greater than 45 grams per mole of amine equivalents. In some embodiments, the low equivalent weight amine curing agent has an amine equivalent weight of no greater than 40, or even no greater than 35 grams per mole of amine equivalents. In some embodiments, two or more low equivalent weight amine curing agents may be used.

The second amine curing agent is a high equivalent weight amine curing agent, i.e., an amine curing agent having an amine equivalent weight of at least 50 grams per mole of equivalents. In some embodiments, the high equivalent weight amine curing agent has an amine equivalent weight of at least 55 grams per mole of amine equivalents. In some embodiments, two or more high equivalent weight amine curing agents may be used.

Exemplary amine curing agents include ethylene amine, ethylene diamine, diethylene diamine, propylene diamine, hexamethylene diamine, 2-methyl-1,5-pentamethylene-diamine, triethylene tetramine, tetraethylene pentamine (“TEPA”), hexaethylene heptamine, and the like. Commercially available amine curing agents include those available from Air Products and Chemicals, Inc. under the trade name ANCAMINE.

In some embodiments, at least one of the amine curing agents is a polyether amine having one or more amine moieties, including those polyether amines that can be derived from polypropylene oxide or polyethylene oxide. Suitable polyether amines that can be used include those available from HUNTSMAN under the trade name JEFFAMINE, and from Air Products and Chemicals, Inc. under the trade name ANCAMINE.

In some embodiments, the relative amounts of the low and high equivalent weight amine curing agents are selected such that the low equivalent weight amine curing agent(s) compose at least 25 wt. %, in some embodiments, at least 30 wt. %, at least 40 wt. %, or even at least 50 wt. %, of the combined weight of the low and high equivalent weight amine curing agents. In some embodiments, the low equivalent weight amine curing agent(s) compose between 30 and 70 wt. %, in some embodiments, between 30 and 60 wt. %, or even between 30 and 50 wt. % of the combined weight of the low and high equivalent weight amine curing agents.

Unless otherwise indicated, all ranges expressed herein are inclusive, i.e., all ranges include the end points of the range. Thus, for example, a range of 30 to 70 wt. % includes 30 wt. %, 70 wt. % and all values in between (e.g., 30.1 wt. %, 40 wt. %, and 69.9 wt. %).

Acetoacetoxy-functionalized compound. The acetoacetoxy-functionalized compound is a material comprising at least one acetoacetoxy group, preferably in a terminal position. Such compounds include acetocetoxy group(s) bearing hydrocarbons, such as alkyls, as well as polyethers, polyols, polyesters, polyhydroxy polyesters, polyoxy polyols, or combinations thereof.

Generally, the acetoacetoxy-functionalized compound is a monomer or relatively low molecular weight oligomer. In some embodiments, the oligomer comprises no greater than 20 repeat units, in some embodiments, no greater than 10, or even no greater than 5 repeat units. In some embodiments, the acetoacetoxy-functionalized oligomer has a molecular weight of no greater than 10,000 g/mol, e.g., no greater than 4,000, no greater than 3000, or even no greater than 1000 g/mol. In some embodiments, the acetoacetoxy-functionalized compound has a molecular weight of at least 100 g/mol, e.g., at least 150, or even at least 200 g/mol.

In some embodiments, the acetoacetoxy-functionalized compound has the general Formula (III):

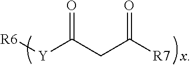

### In Formula (III)

x is an integer from 1 to 10 (e.g., an integer from 1 to 3);

Y represents O, S or NH; and

R⁷ is a linear or branched or cyclic alkyl having 1 to 12 carbon atoms (e.g., methyl, ethyl, propyl, butyl, sec-butyl, tert-butyl, and the like).

In Formula (III), R⁶ is selected from the group consisting of polyoxy, polyhydroxy, polyoxy polyhydroxy, and polyhydroxy polyester-alkys, -aryls, and -alkylaryls (e.g., polyoxy-alkyls, polyoxy-aryls, and polyoxy-alkylaryls); wherein R1 is linked to Y via a carbon atom.

Generally, R6 may be linear or branched. In some embodiments, R6 comprises from 2 to 20 carbon atoms, e.g., from 2 to 10 carbon atoms. In some embodiments, R6 may contain from 2 to 20 oxygen atoms, e.g., from 2 to 10 oxygen atoms.

Acetoacetoxy-functionalized compounds are commercially available, for example, as K-FLEX XM-B301 from King Industries.

The compositions of the present disclosure comprise at least 15 wt. % acetoacetoxy-functionalized compound, based on the total weight of the composition. In some embodiments, the composition comprises at least at least 16 wt. %, or even at least 17 wt. % acetoacetoxy-functionalized compound, based on the total weight of the composition In some embodiments, the composition comprises no greater than 30 wt. %, e.g., no greater than 25 wt. %, or even no greater than 20 wt. % acetoacetoxy-functionalized compound, based on the total weight of the composition.

Metal Salt Catalyst. Suitable metal salt catalysts include the group I metal, group II metal, and lanthanoid salts. In some embodiments, the group I metal cation is lithium. In some embodiments, the group II metal cation is calcium or magnesium. Generally, the anion is selected from nitrates, iodides, thiocyanates, triflates, alkoxides, perchlorates, and sulfonates, including their hydrates. In some embodiments, the anion is a nitrate or a triflate. In some embodiments, the metal salt catalyst may be selected from the group consisting of lanthane nitrate, lanthane triflate, lithium iodide, lithium nitrate, calcium nitrate, calcium triflate, and their corresponding hydrates.

In general, a catalytic amount of salt is employed. In some embodiments, the composition will comprise at least 0.1, e.g., at least 0.5, or even at least 0.8 wt. % catalyst based on the total weight of the composition. In some embodiments, the composition will comprise no greater than 2 wt. %, e.g., no greater than 1.5 wt. %, or even no greater than 1.1 wt. % catalyst based on the total weight of the composition In some embodiments, the composition comprises 0.2 to 2 wt. %, e.g., 0.3 to 1.5 wt. %, or even 0.8 to 1.1 wt. % catalyst based on the total weight of the composition.

The adhesive compositions of the present disclosure may contain any of a wide variety of additional, optional, components. Exemplary, non-limiting, optional additives include the following.

Toughening agents. Toughening agents are polymers capable of increasing the toughness of cured epoxy resins. The toughness can be measured by the peel strength of the cured compositions. Typical toughening agents include core/shell polymers, butadiene-nitrile rubbers, and acrylic polymers and copolymers.

In some embodiments, the toughening agent is a core/shell polymer. In some embodiments, the core may be an elastomer, e.g., an elastomer having a glass transition temperature lower than 0° C. In some embodiments, the core comprises a butadiene polymer or copolymer (e.g., a butadiene-styrene copolymer), an acrylonitrile polymer or copolymer, an acrylate polymer or copolymer, or combinations thereof. In some embodiments, the polymers or copolymers of the core may be cross-linked.

Generally, the shell comprises one or more polymers grafted on to the core. In some embodiments, the shell polymer has a high glass transition temperature, i.e. a glass transition temperature greater than 26° C. The glass transition temperature may be determined by dynamic mechanical thermo analysis (DMTA) (“Polymer Chemistry, The Basic Concepts, Paul C. Hiemenz, Marcel Dekker 1984).

Exemplary core/shell polymers and their preparation are described in, e.g., U.S. Pat. No. 4,778,851. Commercially available core/shell polymers include, e.g., PARALOID EXL 2600 from Rohm & Haas Company, Philadelphia, USA, and KANE ACE MX120 from Kaneka, Belgium.

In some embodiments, the core/shell polymer has an average particle size of at least 10 nm, e.g., at least 150 nm. In some embodiments, the core/shell polymer has an average particle size of no greater than 1,000 nm, e.g., no greater than 500 nm.

In some embodiments, the core/shell polymer may be present in an amount of at least 5 wt. %, e.g., at least 7 wt. %, based on the weight of the total composition. In some embodiments, the core/shell polymer may be present in an amount no greater than 50 wt. %, e.g., no greater than 30 wt. %, e.g., no greater than 15 wt. %, based on the weight of the total composition.

In some embodiments, the composition may also comprise a secondary curative. Exemplary secondary curatives include imidazoles, imidazole-salts, and imidazolines. Aromatic tertiary amines may also be used as secondary curatives, including those having the structure of Formula (IV):

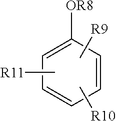

wherein; R8 is H or an alkyl group; R9, R10, and R11 are, independently, hydrogen or CHNR12R13, wherein at least one of R9, R10, and R11 is CHNR12R13; and R12 and R13 are, independently, alkyl groups. In some embodiments, the alkyl groups of R8, R12, and/or R13 are methyl or ethyl groups. One, exemplary secondary curative is tris-2,4,6-(dimethylaminomethyl)phenol, commercially available as ANCAMINE K54 from Air Products Chemicals.

Reactive diluents may be added to control the flow characteristics of the adhesive composition. Suitable diluents can have at least one reactive terminal end portion and, preferably, a saturated or unsaturated cyclic backbone. Preferred reactive terminal ether portions include glycidyl ether.

Fillers may include adhesion promoters, corrosion inhibitors and rheology controlling agents. Exemplary fillers include silica-gels, calcium silicates, phosphates, molybdates, fumed silica, clays such as bentonite or wollastonite, organo-clays, aluminium-trihydrates, hollow-glass-microspheres; hollow-polymeric microspheres, and calcium-carbonate.

Pigments may include inorganic or organic pigments including ferric oxide, brick dust, carbon black, titanium oxide and the like.

### EXAMPLES

### Test Methods

Gel Time Test Method. Gel times were measured at 25° C. with an ARES 4000-0049 rheometer (TA Instruments), using a parallel plate configuration with 25 mm diameter plates and a 0.5 mm gap. Measurements were made in dynamic mode at 1 Hz, starting at 5% strain. The autotension and autostrain settings were used to control the gap and torque during the measurement. After applying samples directly to the bottom plate, the gap was set and the test was started within 30 seconds. The time to reach the crossover point, i.e., the point where the storage modulus (G′) value became greater than the loss modulus (G″) value, was reported as the gel time.

Overlap Shear Adhesion Test Method. Test panels measuring 2.5 cm wide by 10.2 cm long (1 inch by 4 inches) of several different materials were used to evaluate overlap shear adhesion. The bonding surfaces of the panels were cleaned by lightly abrading them using a 3M SCOTCH-BRITE 7447 scouring pad (maroon colored), followed by an isopropyl alcohol wipe to remove any loose debris. A bead of adhesive was then dispensed along one end of a test panel, about 6.4 mm (0.25 inch) from the edge. The panels were joined together face to face along their length to provide an overlap bond area measuring approximately 1.3 cm long and 2.5 cm wide (0.5 inch by 1 inch). A uniform bond line thickness was provided by sprinkling a small amount of 0.2 mm (0.008 inch) diameter solid glass beads on the adhesive before joining the two test panels together. The bonded test panel samples were allowed to dwell at 23° C. (room temperature) for at least 48 hours to ensure full cure of the adhesive. The samples were tested at 22° C. for peak overlap shear strength at a separation rate of 2.5 mm/minute (0.1 inch/minute). The reported values represent the average of three samples.

Rate of Strength Buildup Test Method. Six aluminum test panels measuring 10.2 cm long by 2.5 cm wide by 1.6 mm thick ((4 inches by 1 inch by 0.063 inch) were cleaned and bonded as described above in the Overlap Shear Adhesion Test Method with the following modification. Spacer beads having a diameter of between 0.08 and 0.13 mm (0.003 and 0.005 inches) were used to control the bond line thickness. The bonded test panels were held at room temperature (23° C.) and evaluated for overlap shear strength at periodic intervals from the time the bonds were made.

Low Temperature Impact Test Method. Aluminum test panels measuring 10.2 cm long by 2.5 cm wide by 1.6 mm thick ((4 inches by 1 inch by 0.063 inch) were cleaned and bonded as described above in the Overlap Shear Adhesion Test Method with the following modifications. Methyl ethyl ketone was used in place of isopropyl alcohol; the overlap area was 2.54 cm by 2.54 cm (1 inch by 1 inch); and the spacer beads had a diameter of 0.08 to 0.13 mm (0.003 to 0.005 inches). The bonded sample was allowed to cure for 48 hours at room temperature (23° C.). Next, the cured, bonded sample was equilibrated at −20° C. in a freezer and then tested immediately after removal. Testing was carried out using a pendulum impact tester with a wedge having a weight of 1.4 kilograms, and a height of 50.8 cm. The cured, bonded sample was mounted in a horizontal position and the wedge was in a vertical position at impact on the edge of the overlap section of the sample, i.e., the impact occurred at an angle of 90 degrees. The impact force at failure was recorded. Three samples were tested for each adhesive composition evaluated.

Materials. The materials used in the examples are summarized in Table 1.

TABLE 1
Materials

| Material | Description | Source |
|---|---|---|
| D.E.N. 431 | novolac epoxy (ew(*) = 172) | Dow Chemical Co. |
| EPON 828 | bisphenol A epoxy (ew = 189) | Hexion Specialty Chem. |
| YL 980 | bisphenol A epoxy (ew = 186) | Japan Epoxy Resins |
| ANCAMINE 1922A | propylene oxide diamine (ew = 55) | Air Products |
| ANCAMINE 2678 | proprietary diamine (ew = 30) | Air Products |
| ANCAMINE TEPA | tetraethylenepentamine (ew = 30) | Air Products |
| ANCAMINE K-54 | 2,4,6-tri(dimethylaminomethyl) | Air Products |
| | phenol | |
| ERISYS GA 240 | tetrafunctional epoxy based on | CVC Chemical |
| | 1,3-xylene diamine (ew = 95-110) | |
| XM B301 | acetoacetate (“AcAc”) functional | King Industries |
| | compound (ew = 190) | |
| Z-6040 | 3-glycidoxy propyltrimethoxy | Dow Chemical Co. |
| | silane | |
| KELPOXY 1341 | epoxy-modified, carboxyl- | CVC Chemical |
| | terminated, butadiene-nitrile rubber | |
| KANE-ACE MX-125 | 25 wt. % core shell rubber | Kaneka Texas Corp. |
| (“MX-125”) | dispersed in bisphenol A epoxy | |
| KANE-ACE MX-257 | 37 wt. % core shell rubber | Kaneka Texas Corp. |
| (“MX-257”) | dispersed in bisphenol A epoxy | |
| CaOTf | calcium trifluoromethanesufonate | 3M Co. |
| | (i.e., calcium triflate) | |
| MINEX 7 | alumina silicate | Unimen |
| | (100% < 45 microns) | |
| CB-paste | 80/20 EPON 828 LS/Monarch 120 | Clariant Masterbatches |
| | carbon black dispersion | |
| | (ew = 230-240) | |

(*)ew = equivalent weight in grams per mole of equivalents.

Base Component Preparation Method. Using the compositions summarized in Tables 2a and 2b, all materials were weighed into plastic cups that varied in size depending on the batch size. The materials were mixed at room temperature in a DAC 600 FVZ SPEEDMIXER (Hauschild Engineering, Hamm, Germany) for one to two minutes at 2350-3000 rpm to prepare the base component.

TABLE 2a
Base Component compositions.

| | Weight percent in the base resin (wt. %) | | | | | | |
|---|---|---|---|---|---|---|---|
| | | EPON | Z- | GA- | XMB- | CB- | |
| I.D. | MX-125 | 828 | 6040 | 240 | 301 | paste | MINEX-7 |
| B1 | 43.8 | 33.0 | 0.75 | 22.5 | 0 | 0 | 0 |
| B2 | 43.8 | 33.0 | 0.75 | 0 | 22.5 | 0 | 0 |
| B3 | 43.8 | 31.5 | 0.75 | 0 | 22.5 | 1.5 | 0 |
| B4 | 42.8 | 39.9 | 0.70 | 0 | 14.7 | 0 | 2.0 |

TABLE 2b
Base Component compositions.

| | Weight percent in the base resin (wt. %) | | | | | | |
|---|---|---|---|---|---|---|---|
| | | YL | Z- | DEN | XMB- | CB- | |
| I.D. | MX-257 | 980 | 6040 | 431 | 301 | paste | MINEX-7 |
| B-5 | 29.5 | 33.0 | 0.8 | 18.0 | 18.7 | 0 | 0 |
| B-6 | 29.5 | 33.0 | 0.8 | 14.2 | 22.4 | 0 | 0 |
| B-7 | 28.7 | 32.1 | 0.8 | 10.2 | 25.4 | 0 | 2.9 |
| B-8 | 28.8 | 32.2 | 0.8 | 17.5 | 18.2 | 0 | 2.5 |

Accelerator Component Preparation Method. Accelerator components were prepared according to the compositions summarized in Table 3. The ACAMINE 1922A, 2678, and TEPA amines were weighed into a 0.5 liter can. This mixture was stirred at 350 rpm with an overhead stir motor and impellor blade under a nitrogen stream while heated to 71° C. on a hot plate. The epoxies were added in multiple charges via a syringe at approximately 30 g per addition. The exotherm that occurred after each epoxy addition was allowed to subside such that the temperature of the mixture returned to 71° C. Additional epoxy was added when the temperature had returned to 71° C. This process was repeated until the desired amount of epoxy had been added. If the CaOTf metal salt catalyst was included in the sample, the temperature of amine/epoxy mixture was first raised to 82° C. Next, the CaOTf was added and the mixing speed was increased to 750 rpm. After 30 minutes, the temperature was reduced to 71° C. Upon reaching this temperature, the ANCAMINE K-54 was added, and the accelerator composition was stirred for an additional 5-10 minutes. If any additional fillers were used in the accelerator composition, these materials were added and mixed in using the DAC 600 FVZ SPEEDMIXER as described above for the base resins.

TABLE 3
Accelerator Component (reported in wt. %)

| | ANCAMINE | | | | EPON | KELPOXY | | |
|---|---|---|---|---|---|---|---|---|
| I.D. | 1922A | 2678 | TEPA | K-54 | 828 | 1341 | MINEX-7 | CaOTf |
| A1 | 40.3 | 17.3 | 0 | 3.9 | 13.4 | 23.1 | 2.0 | 0 |
| A2 | 25.4 | 25.4 | 0 | 3.6 | 14.2 | 23.3 | 8.0 | 0 |
| A3 | 39.2 | 16.8 | 0 | 3.7 | 13.0 | 22.5 | 2.0 | 2.9 |
| A4 | 24.7 | 24.7 | 0 | 3.5 | 13.7 | 22.8 | 8.0 | 2.7 |
| A5 | 25.3 | 0 | 25.3 | 3.6 | 14.1 | 23.3 | 8.0 | 0.3 |
| A6 | 37.5 | 0 | 16.1 | 3.8 | 15.0 | 24.3 | 0 | 2.9 |
| A7 | 39.9 | 0 | 17.1 | 3.8 | 13.3 | 22.9 | 2.0 | 0.9 |
| A9 | 34.1 | 22.8 | 0 | 3.8 | 13.2 | 22.9 | 0 | 2.9 |
| A10 | 33.4 | 22.3 | 0 | 3.7 | 12.9 | 22.4 | 2.0 | 2.8 |
| A11 | 71.7 | 0 | 0 | 3.8 | 7.8 | 13.7 | 0 | 2.9 |
| A12 | 70.4 | 0 | 0 | 3.7 | 7.6 | 13.4 | 2.0 | 2.8 |

Two-Part Dispenser. The base resin and the accelerator components were degassed under vacuum at room temperature while mixing. The materials were then loaded into 2:1 DUO-PAK syringes (available from Wilcorp Corporation). The ratio was 2 parts by weight base component to 1 part by weight accelerator component, yielding a 2:1 ratio of epoxy equivalents to amine equivalents. Samples were degassed by placing the syringes in an oven at 70° C. for 15 to 20 minutes. After being removed from the oven and allowed to cool to room temperature, resin was dispensed until a bubble free, even flow from both sides of the cartridge was observed. A static mixer head was used to dispense the adhesives for curing and bonding. A static mixing tip was then attached to the outlet of the syringe.

Various combinations of the base compositions and accelerator compositions were tested for gel point according to the Gel Time Test Method. The various compositions and results are reported in Table 4.

TABLE 4
Gel time results.

| | | | | | Metal | |
|---|---|---|---|---|---|---|
| | | | | | salt | Wt. % Low |
| | Base | Accel. | Gel Time | AcAc (a) | catalyst | ew amine |
| Ex. | 2 pbw | 1 pbw | (min) | (wt. %) | (wt. %) | (b) |
| CE-1 | B1 | A1 | 291 | 0 | 0 | 30 |
| CE-2 | B1 | A2 | 245 | 0 | 0 | 50 |
| CE-3 | B1 | A3 | 166 | 0 | 1.0 | 30 |
| CE-4 | B1 | A4 | 169 | 0 | 0.9 | 50 |
| CE-5 | B4 | A6 | 53 | 9.8 | 1.0 | 30 (c) |
| CE-6 | B2 | A1 | 26 | 15.0 | 0 | 30 |
| CE-7 | B2 | A2 | 24 | 15.0 | 0 | 50 |
| EX-1 | B2 | A3 | 14 | 15.0 | 1.0 | 30 |
| EX-2 | B2 | A4 | 9 | 15.0 | 0.9 | 50 |
| EX-3 | B2 | A5 | 10 | 15.0 | 0.1 | 50 (c) |

(a) acetoacetoxy-functionalized compound
(b) weight % of the low equivalent weight amine curative based on the combined weight of the low and high equivalent weight amine curatives.
(c) ANCAMINE 2678 was replaced with TEPA as the low equivalent weight amine.

As shown in Table 2, much shorter gel times were obtained when the acetoacetoxy-functionalized compound was used. This improvement was observed even though base resin B2 did not include the highly functionalized epoxy resin (i.e., a tetrafunctional epoxy) used in base resin B1 in addition to the bisphenol-A epoxy of B2.

### Example 4

Two parts by weight of base component B2 were combined with one part by weight accelerator component A7, yielding a 2:1 ratio of epoxy equivalents to amine equivalents. The resulting composition contained 15.0 wt. % of a acetoacetoxy-functionalized compound, 0.3 wt. % metal salt catalyst (CaTOf), and 30 wt. % of a low equivalent weight amine curative (TEPA) based on the combined weight of the low and high equivalent weight amine curatives.

### Comparative Example 8

Two parts by weight of base component B5 were combined with one part by weight accelerator component A7, yielding a 2:1 ratio of epoxy equivalents to amine equivalents. The resulting composition was similar to the composition of Example 4; however, Comparative Example 7 only contained 12.1 wt. % of a acetoacetoxy-functionalized compound.

Six 10.2 by 2.5 cm aluminum coupons were bonded with the adhesives of Example 4 and Comparative Example 7 using a 1.3 cm overlap and 3-5 micron spacer beads to control the bond line thickness. The overlap shear strength was measured at periodic intervals from the time the bonds were made according to the Rate of Strength Buildup Test Method. The results are shown in Table 5.

TABLE 5
Rate of strength build-up.

| | Time (min.) | 5 | 10 | 15 | 20 | 25 | 30 | 40 |
|---|---|---|---|---|---|---|---|---|
| Shear | EX-4 | 0.02 | 0.24 | 1.2 | 1.3 | 2.6 | N/A | 3.1 |
| (MPa) | CE-8 | N/A | 0.03 | N/A | 0.09 | N/A | 0.10 | 0.25 |

As summarized in Table 6, various base components and accelerator components were combined in the amounts necessary to provide a 2.1:1 weight ratio of epoxy equivalents to amine equivalents. Six 10.2 by 2.5 cm aluminum coupons were bonded with resulting adhesive with a 1.3 cm overlap and 3-5 micron spacer beads to control the bond line thickness. The overlap shear strength was measured at 10 minute intervals from the time the bonds were made according to the Rate of Strength Buildup Test Method. The results are shown in Table 8.

TABLE 6
Rate of strength build-up.

| | | | AcAc | low ew | | Shear (MPa) | | | |
|---|---|---|---|---|---|---|---|---|---|
| | | | (1) | amine (2) | CaTOf | 10 | 20 | 30 | 40 |
| Ex. | Base | Accel. | wt. % | wt. % | wt. % | min. | min. | min. | min. |
| CE-9 | B5 | A10 | 12.5 | 40 | 0.9 | 0 | 0.02 | 0.04 | 0.06 |
| CE-10 | B6 | A9 | 15.0 | 40 | 1.0 | 0.03 | 0.01 | 0.10 | 0.27 |
| EX-5 | B7 | A9 | 17.0 | 40 | 1.0 | 0.05 | 0.22 | 0.36 | 0.37 |
| CE-11 | B5 | A12 | 12.5 | 0 | 0.9 | 0 | 0 | 0.01 | 0.02 |
| CE-12 | B6 | A11 | 15.0 | 0 | 1.0 | 0 | 0 | 0.01 | 0.01 |
| CE-13 | B7 | A11 | 17.0 | 0 | 1.0 | 0 | 0.01 | 0.01 | 0.01 |

(1) acetoacetoxy-functionalized compound
(2) weight % of the low equivalent weight amine curative based on the combined weight of the low and high equivalent weight amine curatives.

### Example 6

Two parts by weight of base component B3 were combined with one part by weight accelerator component A7, yielding a 2:1 ratio of epoxy equivalents to amine equivalents. The resulting composition contained 15.0 wt. % of a acetoacetoxy-functionalized compound, 0.9 wt. % metal salt catalyst (CaTOf), and 30 wt. % of a low equivalent weight amine curative (TEPA) based on the combined weight of the low and high equivalent weight amine curatives. The adhesive of Example 6 had a viscosity of 80,000 mPa·sec, a 20 g worklife of four minutes, and an initial cure time (i.e., time to reach an overlap shear value of 0.34 MPa) of 10 to 20 minutes.

### Example 7

Two parts by weight of base component B2 were combined with one part by weight accelerator component A3, yielding a 2:1 ratio of epoxy equivalents to amine equivalents. The resulting composition contained 15.0 wt. % of a acetoacetoxy-functionalized compound, 1.0 wt. % metal salt catalyst (CaTOf), and 30 wt. % of a low equivalent weight amine curative (ANCAMINE 2678) based on the combined weight of the low and high equivalent weight amine curatives.

The adhesives of Examples 6 and 7 were applied to various substrates an evaluated according to the Overlap Shear Adhesion Test Method. The substrates and results are summarized in Table 7.

TABLE 7
Overlap shear strength.

Shear (MPa)

| Substrate | EX-6 | EX-7 |
|---|---|---|
| etched aluminum | 29.8 | N/A |
| aluminum | 24.1 | N/A |
| acrylonitrile butadiene styrene (ABS) | 3.9 | 2.6 |
| polyvinylchloride (PVC) | 2.4 | 3.2 |
| polycarbonate (PC) | 2.5 | 3.1 |
| acrylic | N/A | 3.2 |

### Example 8

Two parts by weight of base component B2 were combined with one part by weight accelerator component A7, yielding a 2:1 ratio of epoxy equivalents to amine equivalents. The resulting composition contained 15.0 wt. % of a acetoacetoxy-functionalized compound, 0.9 wt. % metal salt catalyst (CaTOf), and 30 wt. % of a low equivalent weight amine curative (TEPA) based on the combined weight of the low and high equivalent weight amine curatives.

The adhesive of Example 8 was evaluated according to the Low Temperature Impact Test Method. Three replicates were tested. No failure was observed for any of the test specimens.

Various modifications and alterations of this invention will become apparent to those skilled in the art without departing from the scope and spirit of this invention.

1. An adhesive comprising:
(a) an epoxy resin;
(b) a first amine curing agent having an amine equivalent weight of at least 50 grams per mole of amine equivalents;
(c) a second amine curing agent having an amine equivalent weight of no greater than 45 grams per mole of amine equivalents;
(d) an acetoacetoxy-functionalized compound; and
(e) a metal salt catalyst.

2. The adhesive of claim 1, wherein the amine equivalent weight of the first amine curing agent is at least 55 grams per mole of amine equivalents.

3. The adhesive of claim 1, wherein the amine equivalent weight of the second amine curing agent is no greater than 40 grams per mole of amine equivalents.

4. The adhesive according to claim 1, wherein the adhesive comprises greater than 15 wt. % of acetoacetoxy-functionalized compound based on the total weight of the adhesive.

5. The adhesive of claim 4, wherein the adhesive comprises at least 17 wt. % of acetoacetoxy-functionalized compound based on the total weight of the adhesive.

6. The adhesive according to claim 1, wherein the epoxy resin comprises a glycidyl ether of bisphenol-A, bisphenol-F, or novolac.

7. The adhesive according to claim 1, wherein at least one of amine curing agents has the general formula 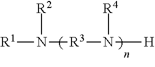
wherein
R¹, R², and R⁴, are independently selected from hydrogen, a hydrocarbon containing 1 to 15 carbon atoms, and a polyether containing 1 to 15 carbon atoms;
R³ represents a hydrocarbon containing 1 to 15 carbon atoms or a polyether containing 1 to 15 carbon atoms; and
n is from 1 to 10, inclusive.

8. The adhesive according to claim 1, wherein the relative amounts of low equivalent weight amine curing agent and high equivalent weight amine curing agent are selected such that the low equivalent weight amine curing agent composes at least 25 wt. % of the combined weight of the low and high equivalent weight amine curing agents.

9. The adhesive according to claim 1, wherein the relative amounts of low equivalent weight amine curing agent and high equivalent weight amine curing agent are selected such that the low equivalent weight amine curing agent composes between 30 and 60 wt. %, inclusive, of the combined weight of the low and high equivalent weight amine curing agents.

10. The adhesive according to claim 1, wherein the acetoacetoxy-functionalized compound has the general formula: 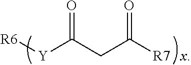
wherein,
x is an integer from 1 to 10;
Y represents O, S or NH;
R6 is selected from the group consisting of polyoxy, polyhydroxy, polyoxy polyhydroxy, and polyhydroxy polyester-alkys, -aryls, and -alkylaryls; wherein R6 is linked to Y via a carbon atom; and
R7 is a linear or branched or cyclic alkyl having 1 to 12 carbon atoms.

11. The adhesive according to claim 1, wherein the metal salt catalyst comprises calcium triflate.

12. The adhesive according to claim 1, wherein the adhesive comprises 0.3 to 1.5 wt. % catalyst, based on the total weight of the composition.

13. The adhesive according to claim 1, wherein the adhesive further comprises a toughening agent.

14. The adhesive of claim 13, wherein the toughening agent comprises at least one of a core shell polymer and a butadiene-nitrile rubber.

15. The adhesive according to claim 1, further comprising an aromatic tertiary amine.

16. The adhesive according to claim 1, wherein the adhesive comprises two components, wherein the first component comprises the acetoacetoxy-functionalized compound and at least a portion of the epoxy resin, and the second component comprises the first amine curing agent, the second amine curing agent, and the metal salt catalyst.

17. The adhesive of claim 16, wherein the second component further comprises a portion of the epoxy resin.

18. The adhesive according to claim 1, wherein the adhesive has a gel time at 25° C. of no greater than 20 minutes as measured according to the Gel Time Test Method.

19. The adhesive according to claim 1, wherein when cured at 23° C., the adhesive has an over-lap shear value of at least 0.34 MPa after no greater than 30 minutes, as measured according to the Rate of Strength Buildup Test Method.

20. An adhesive dispenser comprising a first chamber containing a first component of a two-part adhesive, a second chamber containing a second component of the two-part adhesive, and a mixing tip, wherein the first and second chambers are coupled to the mixing tip to allow the first component and the second component to flow through the mixing tip; wherein the component comprises an epoxy resin and an acetoacetoxy-functionalized compound and the second component comprises a first amine curing agent having an amine equivalent weight of at least 50 grams per mole of amine equivalents; a second amine curing agent having an amine equivalent weight of no greater than 45 grams per mole of amine equivalents; and a metal salt catalyst.

21. The adhesive dispenser of claim 20, wherein at least one of the first or second components further comprise a toughening agent, wherein the toughening agent comprises at least one of a core shell polymer and a butadiene-nitrile rubber.
